(19) United States
(12) Patent Application Publication
(10) Pub. No.: US 2026/0302950 A1
(43) Pub. Date: Oct. 1, 2026

(54) INDUCTOR AND DC-DC CONVERTER

(71) Applicant: TDK Corporation, Tokyo (JP)

(72) Inventors: Hajime KUWAJIMA, Tokyo (JP); Tomofumi KURODA, Tokyo (JP)

(73) Assignee: TDK Corporation, Tokyo (JP)

(21) Appl. No.: 19/578,178

(22) Filed: Mar. 25, 2026

(30) Foreign Application Priority Data
Mar. 26, 2025 (JP) 2025-051898

(51) Int. Cl. H02M 3/158; H01F 17/04; H01F 27/29

(52) U.S. Cl. CPC H02M 3/158; H01F 27/292; H01F 17/04; H01F 2017/048

(57) ABSTRACT

An inductor includes an element body including a resin, first and second coil conductors, and first through fourth terminals exposed from a surface on one side in a first direction. The first and second terminals connect to the first coil conductor and are spaced apart in a second direction. The third and fourth terminals connect to the second coil conductor and are spaced apart in the second direction. The surface includes a first region located between second and third regions in a third direction. The second and third regions protrude further outward in the first direction than the first region. The first terminal is disposed in the second region, and the third terminal is disposed in the third region.

### CROSS-REFERENCE TO RELATED APPLICATIONS

This application is based upon and claims the benefit of priority from Japanese Patent Application No. 2025-051898, filed on 26 Mar. 2025, the entire content of which is incorporated herein by reference.

### TECHNICAL FIELD

The present disclosure relates to an inductor and a DC-DC converter.

### BACKGROUND

Japanese Unexamined Patent Publication No. 2023-19829 discloses an inductor including a magnetic base body (element body), a plurality of internal conductors provided inside the magnetic base body, a plurality of first external electrodes (terminal electrodes) connected to one end of each of the plurality of internal conductors, and a plurality of second external electrodes (terminal electrodes) connected to the other end of each of the plurality of internal conductors.

### SUMMARY

An inductor according to one aspect of the present disclosure includes an element body formed by including a resin, a first coil conductor disposed in the element body, a second coil conductor disposed in the element body, a first terminal connected to the first coil conductor and exposed from a surface on one side in a first direction of the element body, a second terminal connected to the first coil conductor and exposed from the surface on the one side, a third terminal connected to the second coil conductor and exposed from the surface on the one side, and a fourth terminal connected to the second coil conductor and exposed from the surface on the one side, wherein the first terminal and the second terminal are disposed apart from each other in a second direction orthogonal to the first direction, the third terminal and the fourth terminal are disposed apart from each other in the second direction, the surface on the one side has a first region, a second region and a third region, the second region and the third region protruding further out from the element body in the first direction than the first region, the first region is provided between the second region and the third region in a third direction orthogonal to the first direction and the second direction, the first terminal is disposed in the second region, and the third terminal is disposed in the third region.

### BRIEF DESCRIPTION OF THE DRAWINGS

FIG. 1 is a view of an inductor according to a first embodiment viewed from a second side surface side.

FIG. 2 is a view of the inductor shown in FIG. 1 viewed from a third side surface side.

FIG. 3 is a view of the inductor shown in FIG. 1 viewed from a fourth side surface side.

FIG. 4 is a view of the inductor shown in FIG. 1 viewed from a first main surface side.

FIG. 5 is a view of the inductor shown in FIG. 1 viewed from a second main surface side.

FIG. 6 is a view schematically showing a first region, a second region, and a third region of a second main surface.

FIG. 7A and FIG. 7B are views showing a mounting structure of the inductor.

FIG. 8 is a view showing a part of FIG. 7A in an enlarged manner.

FIG. 9 is a view showing a circuit of a DC-DC converter in which the inductor is used.

FIG. 10 is a view of an inductor according to a second embodiment viewed from a second main surface side.

FIG. 11A is a view schematically showing a first region, a second region, and a third region of a second main surface, and FIG. 11B is a view schematically showing a first region, a fourth region, and a fifth region of the second main surface.

FIG. 12 is a view of an inductor according to another embodiment viewed from a second main surface side.

FIG. 13 is a view of an inductor according to another embodiment viewed from a second main surface side.

### DETAILED DESCRIPTION

### Problems to be Solved by the Present Disclosure

When solder-mounting an inductor to a circuit board or the like, the inductor is placed on the circuit board after applying (printing) solder paste to the circuit board, and a reflow process is performed. In this process, if solder remains (solder balls are scattered) between the element body of the inductor and the circuit board (land electrodes), a short circuit may occur between a terminal electrode connected to one internal conductor and a terminal electrode connected to another internal conductor.

An object of one aspect of the present disclosure is to provide an inductor and a DC-DC converter capable of suppressing occurrence of a short circuit defect during mounting.

### Effects of Present Disclosure

According to one aspect of the present disclosure, occurrence of a short circuit defect during mounting can be suppressed.

Description of Embodiments of Present Disclosure

Specific examples of the embodiment of the present disclosure will be described below with reference to the drawings. The present disclosure is not limited to these examples, but is defined by the claims, and is intended to include all modifications within the meaning and scope equivalent to the claims. In the description of the drawings, the same elements are denoted by the same reference numerals, and redundant description thereof will be omitted.

### First Embodiment

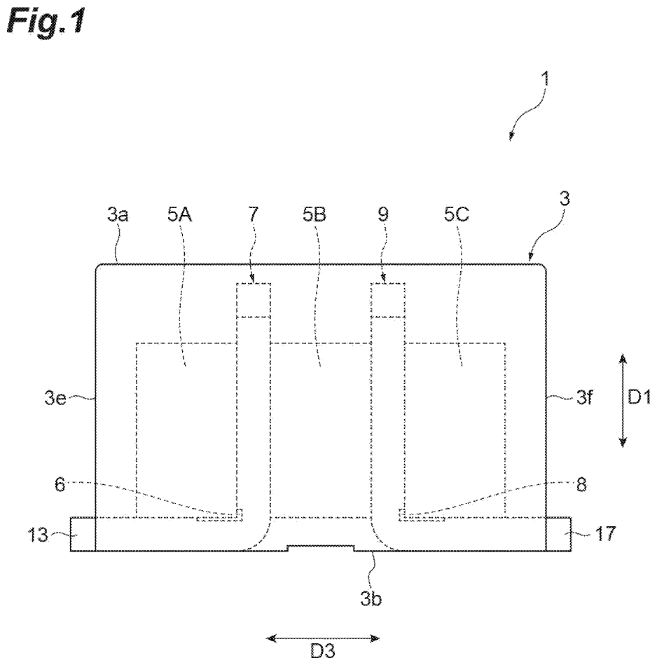

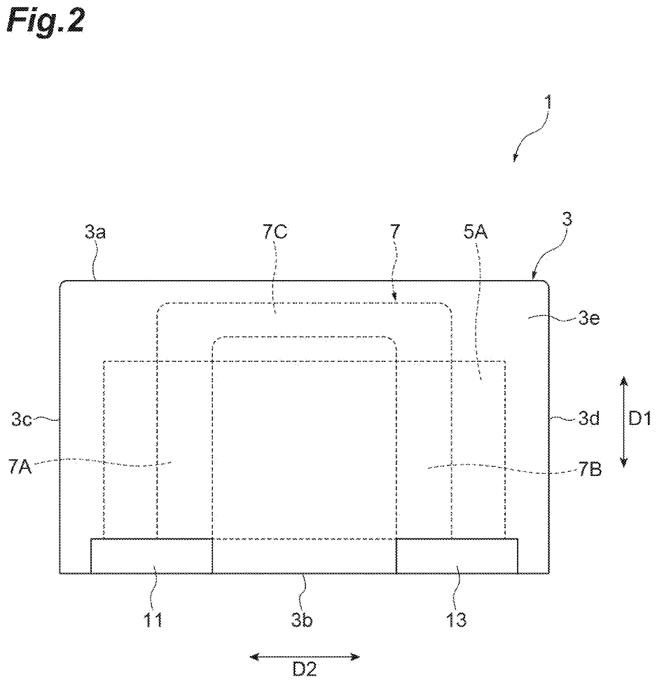

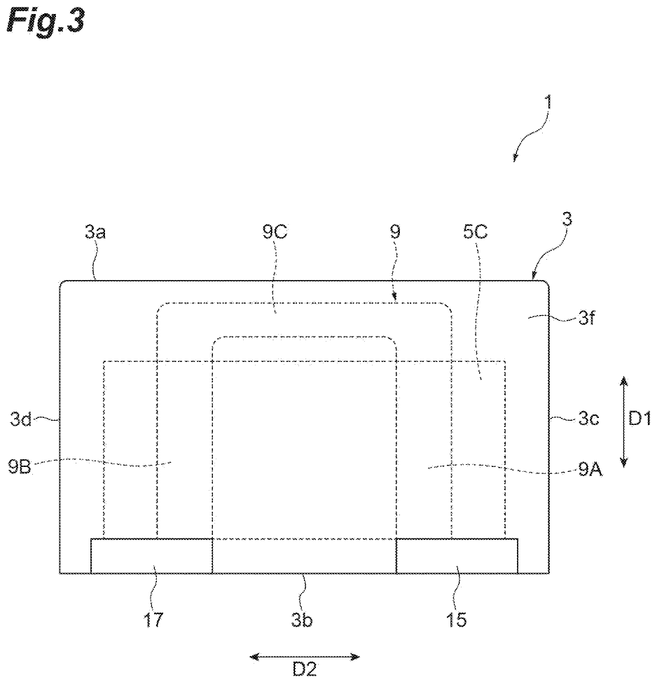

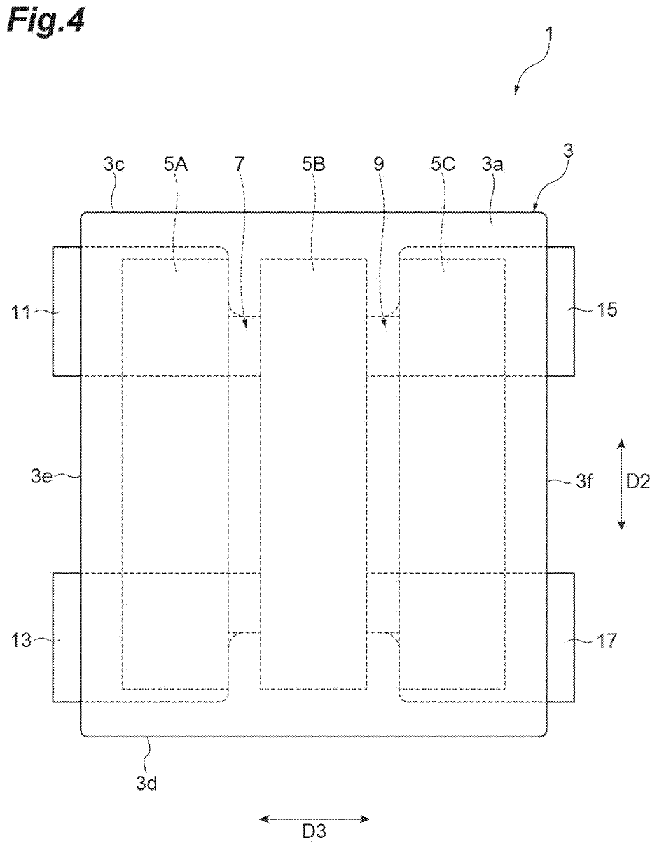

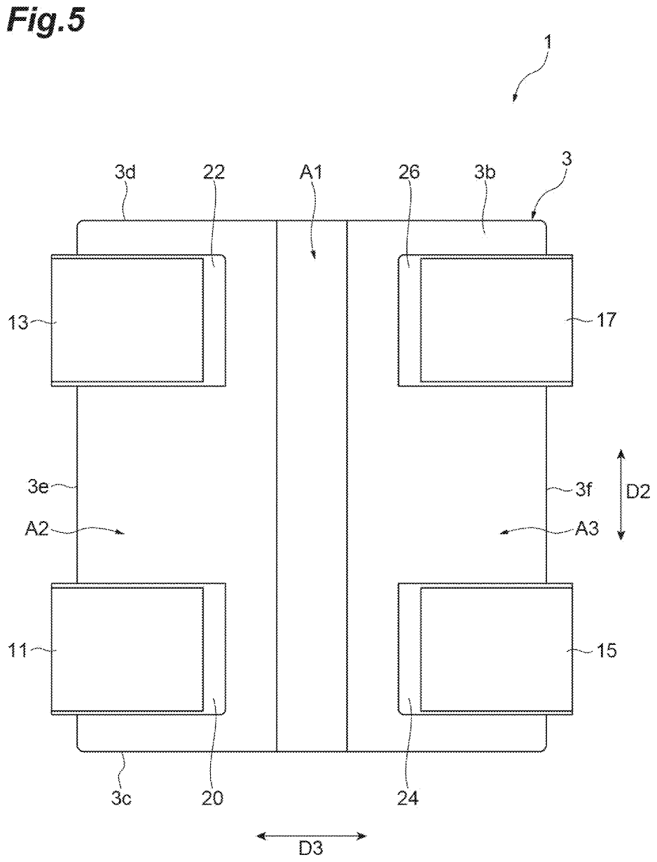

FIG. 1 is a view of an inductor according to a first embodiment viewed from a second side surface. FIG. 2 is a view of the inductor shown in FIG. 1 viewed from a third side surface. FIG. 3 is a view of the inductor shown in FIG. 1 viewed from a fourth side surface. FIG. 4 is a view of the inductor shown in FIG. 1 viewed from a first main surface. FIG. 5 is a view of the inductor shown in FIG. 1 viewed from a second main surface.

As shown in FIGS. 1 to 5, the inductor 1 includes an element body 3, a first magnetic block 5A, a second magnetic block 5B, and a third magnetic block 5C, a first coil conductor 7 and a second coil conductor 9, and a first terminal 11, a second terminal 13, a third terminal 15, and a fourth terminal 17.

The element body 3 exhibits a rectangular parallelepiped shape. The rectangular parallelepiped shape includes a rectangular parallelepiped shape in which corner portions and ridge line portions are chamfered, and a rectangular parallelepiped shape in which corner portions and ridge line portions are rounded. The element body 3 has, as outer surfaces thereof, a first main surface 3a and a second main surface (mounting surface) 3b facing each other, and a first side surface 3c, a second side surface 3d, a third side surface 3e, and a fourth side surface 3f connecting the first main surface 3a and the second main surface 3b. The first side surface 3c and the second side surface 3d face each other. The third side surface 3e and the fourth side surface 3f face each other. An opposing direction in which the first main surface 3a and the second main surface 3b face each other is a first direction D1. An opposing direction in which the first side surface 3c and the second side surface 3d face each other is a second direction D2. An opposing direction in which the third side surface 3e and the fourth side surface 3f face each other is a third direction D3.

In the present embodiment, the first direction D1 is a height direction of the element body 3. The second direction D2 is, for example, a width direction of the element body 3, and is orthogonal to the first direction D1. The third direction D3 is, for example, a length direction of the element body 3, and is orthogonal to the second direction D2 and the first direction D1.

The second main surface 3b can be defined as a mounting surface facing another electronic device when the inductor 1 is mounted on the other electronic device (for example, a circuit board or an electronic component).

The element body 3 is formed by including a resin. In the present embodiment, the element body 3 can be configured with a magnetic resin. The magnetic resin is a resin containing magnetic powder, and a thermosetting resin such as epoxy is adopted as a material of the resin. As the magnetic resin, a mixture of soft magnetic metal powder and resin or the like may be adopted. As the soft magnetic metal powder, an iron-silicon alloy, permalloy, sendust, amorphous, nanocrystalline alloy, or a mixture thereof can be used. Further, when the element body 3 is configured with a magnetic resin, the magnetic permeability of the element body 3 may be 5 or more, and may be 20 or more. Furthermore, the magnetic permeability of the element body 3 may be 100 or less, and may be 50 or less. The element body 3 may have a lower magnetic permeability than the first magnetic block 5A, the second magnetic block 5B, and the third magnetic block 5C.

The first magnetic block 5A, the second magnetic block 5B, and the third magnetic block 5C are disposed in the element body 3. The first magnetic block 5A, the second magnetic block 5B, and the third magnetic block 5C are arranged in a state of facing each other while being spaced apart from each other in the third direction D3 in this order. Each of the first magnetic block 5A, the second magnetic block 5B, and the third magnetic block 5C has a rectangular parallelepiped shape. Each of the first magnetic block 5A, the second magnetic block 5B, and the third magnetic block 5C may have the same shape. Note that each of the first magnetic block 5A, the second magnetic block 5B, and the third magnetic block 5C may have a shape different from each other, or the first magnetic block 5A and the third magnetic block 5C may have the same shape, and the first magnetic block 5A and the third magnetic block 5C and the second magnetic block 5B may have different shapes.

Each of the first magnetic block 5A, the second magnetic block 5B, and the third magnetic block 5C can be made of a magnetic material such as, for example, a sintered magnetic core such as MnZn-based ferrite or NiZn-based ferrite, or a laminated magnetic core formed by laminating soft magnetic metal plates. The magnetic permeability of each of the first magnetic block 5A, the second magnetic block 5B, and the third magnetic block 5C may be 1000 or more. Further, each of the first magnetic block 5A, the second magnetic block 5B, and the third magnetic block 5C may have substantially the same magnetic properties, or may have different magnetic properties.

As shown in FIG. 4, the first magnetic block 5A is disposed at a position near the third side surface 3e of the element body 3. The third magnetic block 5C is disposed at a position near the fourth side surface 3f of the element body 3. The second magnetic block 5B is disposed between the first magnetic block 5A and the third magnetic block 5C. As shown in FIGS. 1 and 4, the first magnetic block 5A, the second magnetic block 5B, and the third magnetic block 5C are disposed at the same position such that main surfaces and side surfaces overlap each other. Note that a positional deviation within a range caused by a manufacturing error or the like is included in the “same position”.

The first magnetic block 5A is placed on the first terminal 11 and the second terminal 13. The third magnetic block 5C is placed on the third terminal 15 and the fourth terminal 17. A main surface on the first main surface 3a side of the element body 3 in each of the first magnetic block 5A, the second magnetic block 5B, and the third magnetic block 5C is located closer to the second main surface 3b side of the element body 3 in the first direction D1 than each of a third conductor 7C (described later) of the first coil conductor 7 and a sixth conductor 9C (described later) of the second coil conductor 9. Accordingly, when viewed from the third direction D3, a part of an opening formed by a first conductor 7A (described later), a second conductor 7B (described later), and the third conductor 7C of the first coil conductor 7 does not overlap with the first magnetic block 5A, the second magnetic block 5B, and the third magnetic block 5C. Also, when viewed from the third direction D3, a part of an opening formed by a fourth conductor 9A (described later), a fifth conductor 9B (described later), and the sixth conductor 9C of the second coil conductor 9 does not overlap with the first magnetic block 5A, the second magnetic block 5B, and the third magnetic block 5C.

A width in the second direction D2 of each of the first magnetic block 5A, the second magnetic block 5B, and the third magnetic block 5C is wider than a width in the second direction D2 of the first coil conductor 7 (a distance between an end on the first side surface 3c side of the first conductor 7A and an end on the second side surface 3d side of the second conductor 7B). The width in the second direction D2 of each of the first magnetic block 5A, the second magnetic block 5B, and the third magnetic block 5C is wider than a width in the second direction D2 of the second coil conductor 9 (a distance between an end on the first side surface 3c side of the fourth conductor 9A and an end on the second side surface 3d side of the fifth conductor 9B).

As shown in FIGS. 1 to 3, the first coil conductor 7 and the second coil conductor 9 are disposed in the element body 3. The first coil conductor 7 and the second coil conductor 9 are aligned with the second magnetic block 5B interposed therebetween. The first coil conductor 7 and the second coil conductor 9 are made of a metal selected from, for example, Cu, Ag, Au, Al, Ni, Sn, and the like. The first coil conductor 7 and the second coil conductor 9 are covered with an insulating coating (not shown). That is, an insulating film is interposed between a surface of each of the first coil conductor 7 and the second coil conductor 9 and the element body 3.

The first coil conductor 7 is disposed at a position near the third side surface 3e of the element body 3. The first coil conductor 7 is disposed between the first magnetic block 5A and the second magnetic block 5B. The first coil conductor 7 is configured to include the first conductor 7A, the second conductor 7B, and the third conductor 7C. The first conductor 7A, the second conductor 7B, and the third conductor 7C are integrally formed.

The first conductor 7A is disposed at a position near the first side surface 3c of the element body 3. The first conductor 7A extends along the first direction D1. The second conductor 7B is disposed at a position near the second side surface 3d of the element body 3. The second conductor 7B extends along the first direction D1. The second conductor 7B is disposed at a position facing the first conductor 7A in the second direction D2. The second conductor 7B is disposed at a predetermined interval from (aligned with) the first conductor 7A in the second direction D2. The third conductor 7C connects the first conductor 7A and the second conductor 7B. The third conductor 7C connects an end on the first main surface 3a side of the first conductor 7A and an end on the first main surface 3a side of the second conductor 7B. The third conductor 7C extends along the second direction D2.

The second coil conductor 9 is disposed at a position near the fourth side surface 3f of the element body 3. The second coil conductor 9 is disposed between the second magnetic block 5B and the third magnetic block 5C. The second coil conductor 9 is configured to include the fourth conductor 9A, the fifth conductor 9B, and the sixth conductor 9C. The fourth conductor 9A, the fifth conductor 9B, and the sixth conductor 9C are integrally formed.

The fourth conductor 9A is disposed at a position near the first side surface 3c of the element body 3. The fourth conductor 9A extends along the first direction D1. The fifth conductor 9B is disposed at a position near the second side surface 3d of the element body 3. The fifth conductor 9B extends along the first direction D1. The fifth conductor 9B is disposed at a position facing the fourth conductor 9A in the second direction D2. The fifth conductor 9B is disposed at a predetermined interval from (aligned with) the fourth conductor 9A in the second direction D2. The sixth conductor 9C connects the fourth conductor 9A and the fifth conductor 9B. The sixth conductor 9C connects an end on the first main surface 3a side of the fourth conductor 9A and an end on the first main surface 3a side of the fifth conductor 9B. The sixth conductor 9C extends along the second direction D2.

The first terminal 11 is exposed from the second main surface 3b. The first terminal 11 is disposed at a position near the first side surface 3c and near the third side surface 3e of the element body 3. An insulating member (first insulating member) 20 is provided between the first terminal 11 and the element body 3. The first terminal 11 is connected to one end of the first coil conductor 7. The first terminal 11 is connected to an end on the second main surface 3b side of the first conductor 7A. The first terminal 11 has a rectangular parallelepiped shape. A width in the second direction D2 of the first terminal 11 is larger than a width in the second direction D2 of the first conductor 7A. In the present embodiment, the first terminal 11 protrudes to the outside of the element body 3 relative to the third side surface 3e of the element body 3. As shown in FIG. 2, an end surface of the first terminal 11 is exposed when viewed from the third direction D3.

As shown in FIG. 5, the second terminal 13 is exposed from the second main surface 3b. The second terminal 13 is disposed at a position near the second side surface 3d and near the third side surface 3e of the element body 3. The second terminal 13 is connected to the other end of the first coil conductor 7. The second terminal 13 is connected to an end on the second main surface 3b side of the second conductor 7B. An insulating member (second insulating member) 22 is provided between the second terminal 13 and the element body 3. The second terminal 13 has a rectangular parallelepiped shape. A width in the second direction D2 of the second terminal 13 is larger than a width in the second direction D2 of the second conductor 7B. In the present embodiment, the second terminal 13 protrudes to the outside of the element body 3 relative to the third side surface 3e of the element body 3. As shown in FIG. 2, an end surface of the second terminal 13 is exposed when viewed from the third direction D3.

As shown in FIG. 5, the third terminal 15 is exposed from the second main surface 3b. The third terminal 15 is disposed at a position near the first side surface 3c and near the fourth side surface 3f of the element body 3. The third terminal 15 is connected to one end of the second coil conductor 9. The third terminal 15 is connected to an end on the second main surface 3b side of the fourth conductor 9A. An insulating member (third insulating member) 24 is provided between the third terminal 15 and the element body 3. The third terminal 15 has a rectangular parallelepiped shape. A width in the second direction D2 of the third terminal 15 is larger than a width in the second direction D2 of the fourth conductor 9A. In the present embodiment, the third terminal 15 protrudes to the outside of the element body 3 relative to the fourth side surface 3f of the element body 3. As shown in FIG. 3, an end surface of the third terminal 15 is exposed when viewed from the third direction D3.

As shown in FIG. 5, the fourth terminal 17 is exposed from the second main surface 3b. The fourth terminal 17 is disposed at a position near the second side surface 3d and near the fourth side surface 3f of the element body 3. The fourth terminal 17 is connected to the other end of the second coil conductor 9. The fourth terminal 17 is connected to an end on the second main surface 3b side of the fifth conductor 9B. An insulating member (fourth insulating member) 26 is provided between the fourth terminal 17 and the element body 3. The fourth terminal 17 has a rectangular parallelepiped shape. A width in the second direction D2 of the fourth terminal 17 is larger than a width in the second direction D2 of the fifth conductor 9B. In the present embodiment, the fourth terminal 17 protrudes to the outside of the element body 3 relative to the fourth side surface 3f of the element body 3. As shown in FIG. 3, an end surface of the fourth terminal 17 is exposed when viewed from the third direction D3.

As shown in FIG. 5, the first terminal 11 and the second terminal 13 are disposed at positions facing each other at a predetermined interval in the second direction D2. The third terminal 15 and the fourth terminal 17 are disposed at positions facing each other at a predetermined interval in the second direction D2. The first terminal 11 and the third terminal 15 are disposed at positions facing each other at a predetermined interval in the third direction D3. The second terminal 13 and the fourth terminal 17 are disposed at positions facing each other at a predetermined interval in the third direction D3.

As shown in FIG. 1, a recess 6 may be provided in a connection portion between the second terminal 13 and the second conductor 7B of the first coil conductor 7. A recess 8 may be provided in a connection portion between the fourth terminal 17 and the fifth conductor 9B of the second coil conductor 9. Similarly, a recess may be provided in a connection portion between the first terminal 11 and the first conductor 7A of the first coil conductor 7. A recess may be provided in a connection portion between the third terminal 15 and the fourth conductor 9A of the second coil conductor 9.

A plating layer (not shown) containing, for example, Ni, Cu, Sn, Ag, Au, or the like may be provided on the first terminal 11, the second terminal 13, the third terminal 15, and the fourth terminal 17 by applying electrolytic plating or electroless plating. The plating layer may be configured to include, for example, a plurality of plating films.

Subsequently, a configuration of the second main surface 3b of the element body 3 will be described in detail.

The second main surface 3b of the element body 3 is configured to include a first region A1, a second region A2, and a third region A3.

The first region A1 is provided in a central portion in the third direction D3 on the second main surface 3b. The first region A1 extends in the second direction D2 between the first side surface 3c and the second side surface 3d of the element body 3. The first region A1 has a predetermined width in the third direction D3.

The second region A2 protrudes to the outside of the element body 3 in the first direction D1 relative to the first region A1. In other words, the first region A1 is recessed toward the first main surface 3a side relative to the second region A2. The second region A2 is provided on the third side surface 3e side of the element body 3 relative to the first region A1. The second region A2 extends in the second direction D2 between the first side surface 3c and the second side surface 3d of the element body 3. The second region A2 has a predetermined width in the third direction D3. The width of the second region A2 is larger than the width of the first region A1.

The third region A3 protrudes to the outside of the element body 3 in the first direction D1 relative to the first region A1. In other words, the first region A1 is recessed toward the first main surface 3a side relative to the third region A3. The third region A3 is provided on the fourth side surface 3f side of the element body 3 relative to the first region A1. That is, the first region A1 is provided between the second region A2 and the third region A3 in the third direction D3. The third region A3 extends in the second direction D2 between the first side surface 3c and the second side surface 3d of the element body 3. The third region A3 has a predetermined width in the third direction D3. The width of the third region A3 is larger than the width of the first region A1. The width of the third region A3 is equivalent to the width of the second region A2.

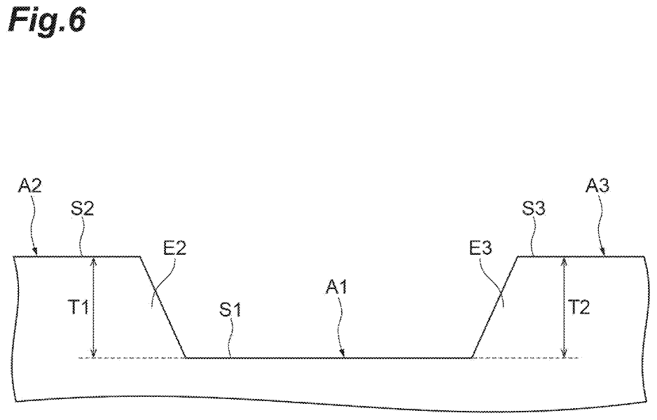

FIG. 6 is a view schematically showing the first region A1, the second region A2, and the third region A3 of the second main surface 3b. As shown in FIG. 6, protrusion amounts of the second region A2 and the third region A3 relative to the first region A1 are equivalent. That is, a height position of a surface S2 of the second region A2 and a height position of a surface S3 of the third region A3 are equivalent. The protrusion amount of the second region A2 relative to the first region A1, that is, a distance T1 between the surface S2 of the second region A2 and a surface S1 of the first region A1 is 10 μm to 200 μm. Similarly, the protrusion amount of the third region A3 relative to the first region A1, that is, a distance T2 between the surface S3 of the third region A3 and the surface S1 of the first region A1 is 10 μm to 200 μm.

The distance T1 and the distance T2 are equal to or less than a maximum thickness (dimension in the first direction D1) of each of the first terminal 11, the second terminal 13, the third terminal 15, and the fourth terminal 17. The distance T1 and the distance T2 are equal to or greater than a difference between a maximum value and a minimum value of a dimension protruding from the first region A1 of the second main surface 3b of the element body 3 for each of the first terminal 11, the second terminal 13, the third terminal 15, and the fourth terminal 17. That is, the distance T1 and the distance T2 are equal to or greater than a difference between a maximum value and a minimum value of a distance between a surface of each of the first terminal 11, the second terminal 13, the third terminal 15, and the fourth terminal 17 and the surface S1 of the first region A1. For example, when the first terminal 11 protrudes most relative to the first region A1 (the distance between the surface of the first terminal 11 and the surface S1 of the first region A1 is the maximum value) and the second terminal 13 protrudes least relative to the first region A1 (the distance between the surface of the second terminal 13 and the surface S1 of the first region A1 is the minimum value), the distance T1 and the distance T2 are set to be equal to or greater than a difference between the maximum value of the first terminal 11 and the minimum value of the second terminal 13.

Each of an edge portion E2 of the second region A2 adjacent to the first region A1 and an edge portion E3 of the third region A3 adjacent to the first region A1 has a protrusion amount that becomes smaller (gradually) toward the first region A1. Each of the edge portion E2 of the second region A2 and the edge portion E3 of the third region A3 has a tapered shape that tapers toward the first region A1. Note that the edge portion E2 and the edge portion E3 may have a linear tapered shape, or may have a curved (convex, concave) tapered shape.

An area of the first region A1 is smaller than an area obtained by summing respective areas of the second region A2 and the third region A3. That is, a ratio occupied by the first region A1 in the second main surface 3b is smaller than a ratio occupied by the second region A2 and the third region A3. In the element body 3, the first region A1, the second region A2, and the third region A3 of the second main surface 3b can be formed by embossing, laser processing, machining, or the like.

Subsequently, arrangement of the first terminal 11, the second terminal 13, the third terminal 15, and the fourth terminal 17 will be described in detail.

The first terminal 11 is disposed in the second region A2 on the second main surface 3b. The second terminal 13 is disposed in the second region A2 on the second main surface 3b. In the present embodiment, the surface of the first terminal 11 and the surface of the second terminal 13 are substantially flush with the surface S2 of the second region A2.

The third terminal 15 is disposed in the third region A3 on the second main surface 3b. The fourth terminal 17 is disposed in the third region A3 on the second main surface 3b. In the present embodiment, the surface of the third terminal 15 and the surface of the fourth terminal 17 are substantially flush with the surface S3 of the third region A3.

The first terminal 11 and the third terminal 15 are disposed with the first region A1 interposed therebetween. The second terminal 13 and the fourth terminal 17 are disposed with the first region A1 interposed therebetween.

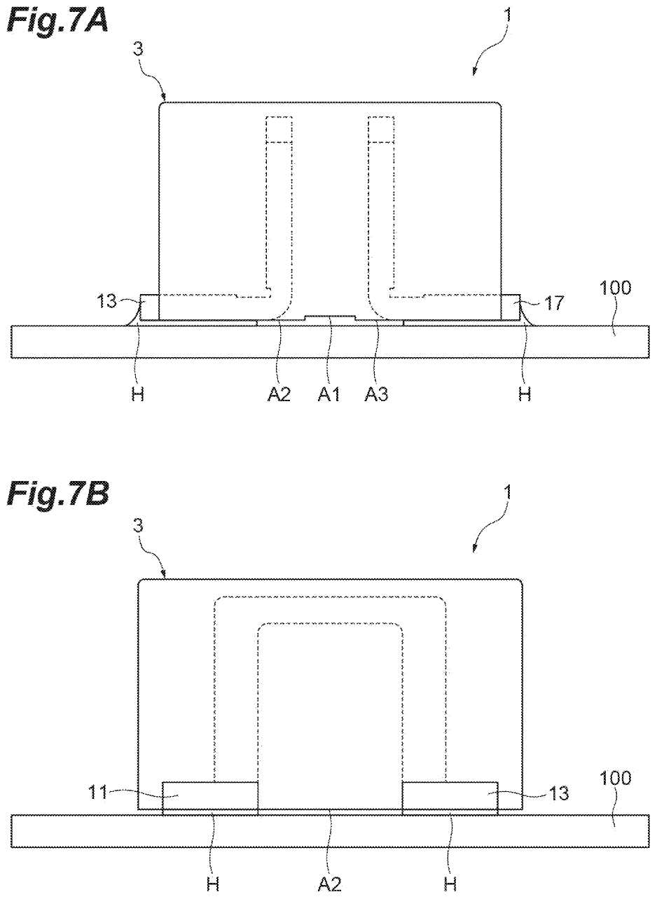

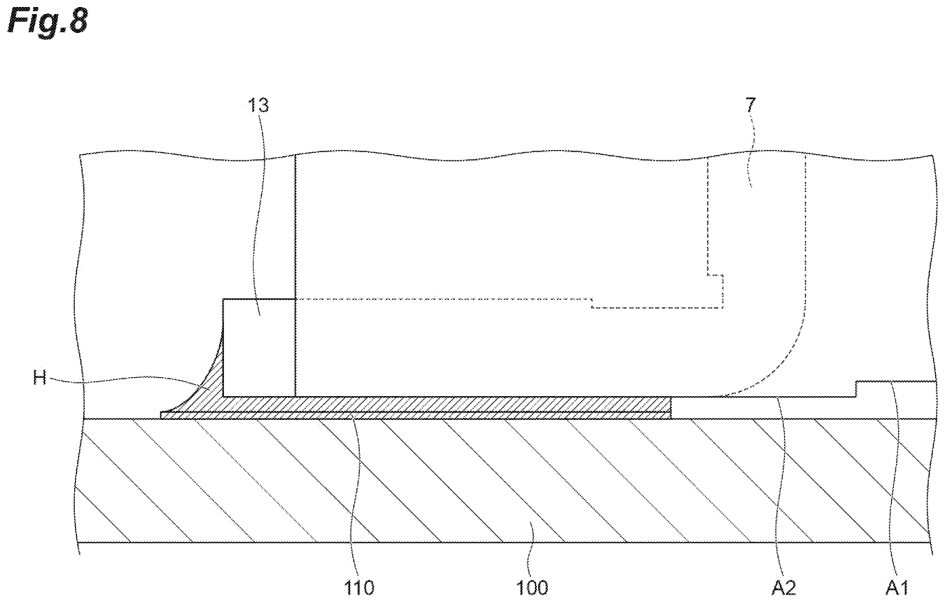

FIG. 7A and FIG. 7B are views showing a mounting structure of the inductor 1. FIG. 8 is a view showing a part of FIG. 7A in an enlarged manner. As shown in FIG. 7A, FIG. 7B, and FIG. 8, the inductor 1 is mounted on a circuit board 100 with solder H. Specifically, the first terminal 11, the second terminal 13, the third terminal 15, and the fourth terminal 17 of the inductor 1 are joined to land electrodes 110 of the circuit board 100 by the solder H.

The solder H is formed on surfaces and end surfaces (protruding portions) of the first terminal 11, the second terminal 13, the third terminal 15, and the fourth terminal 17. Thus, in the configuration in which the first terminal 11, the second terminal 13, the third terminal 15, and the fourth terminal 17 protrude from the element body 3, a force pulling the inductor 1 toward the circuit board 100 side is exerted by the solder H. This can shorten a distance between the circuit board 100 and the element body 3. In the inductor 1, since the second region A2 and the third region A3 of the second main surface 3b protrude relative to the first region A1, even if the distance between the second region A2 and the third region A3 and the circuit board 100 shortens, a space is secured between the second region A2 and the third region A3 by the first region A1.

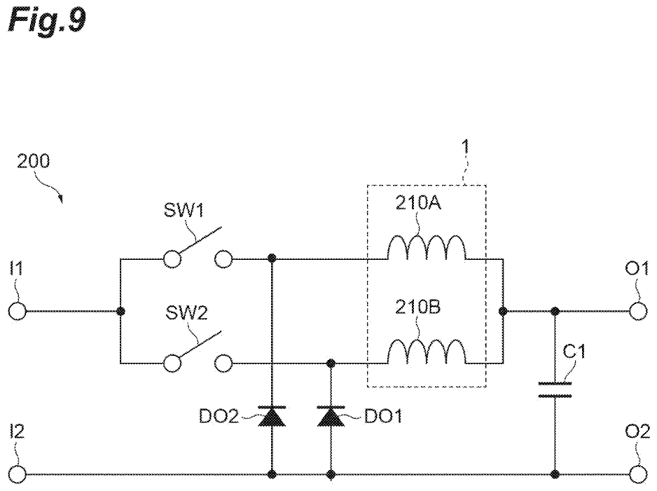

FIG. 9 is a view showing a circuit of a DC-DC converter in which the inductor 1 is used. As shown in FIG. 9, the first coil conductor 7 and the second coil conductor 9 of the inductor 1 can be adopted for respective choke coils of a circuit of a DC-DC converter 200. The DC-DC converter 200 is a multiphase converter including a pair of conversion units formed of switching elements SW1, SW2, choke coils 210A, 210B, and diodes DO1, DO2, wherein these conversion units are connected in parallel, and the inductor 1 can be adopted as the choke coils 210A, 210B of each conversion unit.

The DC-DC converter 200 includes a pair of input terminals I1, I2, a pair of output terminals O1, O2, the switching element SW1 and the choke coil 210A connected in series in this order between the input terminal I1 and the output terminal O1, the switching element SW2 and the choke coil 210B connected in series in this order between the input terminal I1 and the output terminal O1, and a capacitor C1 connected between the output terminals O1, O2. A circuit consisting of the switching element SW1 and the choke coil 210A and a circuit consisting of the switching element SW2 and the choke coil 210B are connected in parallel between the input terminal I1 and the output terminal O1. The input terminal I2 and the output terminal O2 constitute a ground line.

The diode DO2 is connected in a reverse direction between a connection point of the switching element SW1 and the choke coil 210A and the ground line, and the diode DO1 is connected in a reverse direction between a connection point of the switching element SW2 and the choke coil 210B and the ground line. The switching elements SW1, SW2 are alternately turned on and off by a control circuit (not shown), whereby an output voltage obtained by stepping down an input voltage is generated. By configuring the pair of choke coils 210A, 210B in the DC-DC converter 200 with the first coil conductor 7 and the second coil conductor 9 of the inductor 1, reduction in the number of components configuring the DC-DC converter 200 can be achieved.

As described above, in the inductor 1 according to the present embodiment, the second main surface 3b of the element body 3 has the first region A1, the second region A2, and the third region A3. The second region A2 and the third region A3 protrude to the outside of the element body 3 relative to the first region A1. That is, the first region A1 is recessed (depressed) relative to the second region A2 and the third region A3. In this configuration, the first terminal 11 and the second terminal 13 are disposed in the second region A2, and the third terminal 15 and the fourth terminal 17 are disposed in the third region A3. Accordingly, when mounting the inductor 1 (the first terminal 11, the second terminal 13, the third terminal 15, the fourth terminal 17) to a circuit board or the like with solder, a space is formed between the first region A1 of the element body 3 and the circuit board. Therefore, since solder can flow between the element body 3 and the circuit board, it is possible to suppress solder from remaining between the element body 3 and the circuit board. Therefore, in the inductor 1, it is possible to suppress occurrences of short circuits with solder between the first and second terminals 11, 13 and the third and fourth terminals 15, 17. As a result, in the inductor 1, occurrence of a short circuit defect during mounting can be suppressed.

In the inductor 1 according to the present embodiment, the area of the first region A1 is smaller than the area obtained by summing the respective areas of the second region A2 and the third region A3. In this configuration, when the inductor 1 is mounted on the circuit board 100, fixing strength between the inductor 1 and the circuit board 100 can be increased, so that mounting stability can be increased. Also, rigidity of the element body 3 of the inductor 1 can be increased. Furthermore, in the above configuration, since areas of the first terminal 11, the second terminal 13, the third terminal 15, and the fourth terminal 17 disposed in the second region A2 and the third region A3 respectively can be increased, heat dissipation can be enhanced.

In the inductor 1 according to the present embodiment, the protrusion amount of each of the edge portions E2, E3 of the second region A2 and the third region A3 becomes smaller toward the first region A1. In this configuration, when mounting the inductor 1 (the first terminal 11, the second terminal 13, the third terminal 15, the fourth terminal 17) to a circuit board or the like with solder, when solder flows between the first region A1 of the element body 3 and the circuit board, the solder easily moves toward solder between the first terminal 11, the second terminal 13, the third terminal 15, or the fourth terminal 17 and the circuit board (land electrode). Therefore, it is possible to suppress solder from remaining between the element body 3 and the circuit board.

In the inductor 1 according to the present embodiment, the distance T1 and the distance T2 are equal to or less than the maximum thickness (dimension in the first direction D1) of each of the first terminal 11, the second terminal 13, the third terminal 15, and the fourth terminal 17. The distance T1 and the distance T2 are equal to or greater than the difference between the maximum value and the minimum value of the dimension protruding from the first region A1 of the second main surface 3b of the element body 3 for each of the first terminal 11, the second terminal 13, the third terminal 15, and the fourth terminal 17. In this configuration, when mounting the inductor 1 (the first terminal 11, the second terminal 13, the third terminal 15, the fourth terminal 17) to a circuit board or the like with solder, a space in which solder can flow can be formed between the first region A1 of the element body 3 and the circuit board.

### Second Embodiment

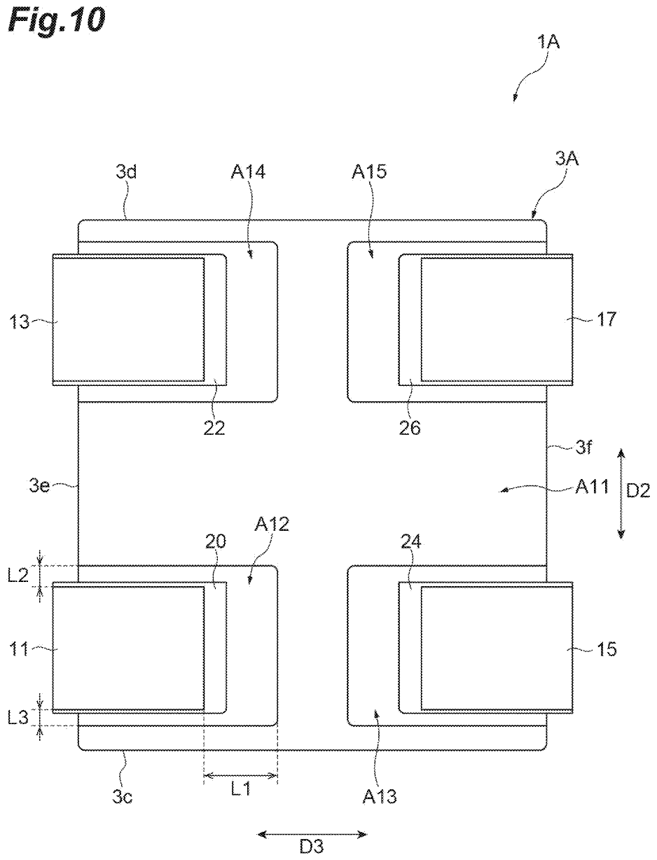

Subsequently, an inductor according to a second embodiment will be described. FIG. 10 is a view of the inductor according to a second embodiment viewed from a second main surface side.

The inductor 1A shown in FIG. 10 includes an element body 3A, a first magnetic block 5A, a second magnetic block 5B, and a third magnetic block 5C, a first coil conductor 7 and a second coil conductor 9, and a first terminal 11, a second terminal 13, a third terminal 15, and a fourth terminal 17, similarly to the inductor 1 according to the first embodiment.

As shown in FIG. 10, a second main surface 3b of the element body 3A of the inductor 1A is configured to include a first region A11, a second region A12, a third region A13, a fourth region A14, and a fifth region A15.

The first region A11 is provided in a central portion and both end portions in the second direction D2, and a central portion in the third direction D3 on the second main surface 3b. The first region A11 extends in the second direction D2 between a first side surface 3c and a second side surface 3d of the element body 3. The first region A11 extends in the third direction D3 between a third side surface 3e and a fourth side surface 3f of the element body 3.

The second region A12 protrudes to the outside of the element body 3 in the first direction D1 relative to the first region A11. In other words, the first region A11 is recessed toward the first main surface 3a side relative to the second region A12. The second region A12 is provided at a position on the third side surface 3e side and near the first side surface 3c of the element body 3. The second region A12 has a substantially rectangular shape.

The third region A13 protrudes to the outside of the element body 3 in the first direction D1 relative to the first region A11. In other words, the first region A11 is recessed toward the first main surface 3a side relative to the third region A13. The third region A13 is provided at a position on the fourth side surface 3f side and near the first side surface 3c of the element body 3. The third region A13 has a substantially rectangular shape.

The fourth region A14 protrudes to the outside of the element body 3 in the first direction D1 relative to the first region A11. In other words, the first region A11 is recessed toward the first main surface 3a side relative to the fourth region A14. The fourth region A14 is provided at a position on the third side surface 3e side and near the second side surface 3d of the element body 3. The fourth region A14 has a substantially rectangular shape.

The fifth region A15 protrudes to the outside of the element body 3 in the first direction D1 relative to the first region A11. In other words, the first region A11 is recessed toward the first main surface 3a side relative to the fifth region A15. The fifth region A15 is provided at a position on the fourth side surface 3f side and near the second side surface 3d of the element body 3. The fifth region A15 has a substantially rectangular shape.

The second region A12 and the third region A13 are disposed facing each other with the first region A11 interposed therebetween in the third direction D3. The fourth region A14 and the fifth region A15 are disposed facing each other with the first region A11 interposed therebetween in the third direction D3. The second region A12 and the fourth region A14 are disposed facing each other with the first region A11 interposed therebetween in the second direction D2. The third region A13 and the fifth region A15 are disposed facing each other with the first region A11 interposed therebetween in the second direction D2.

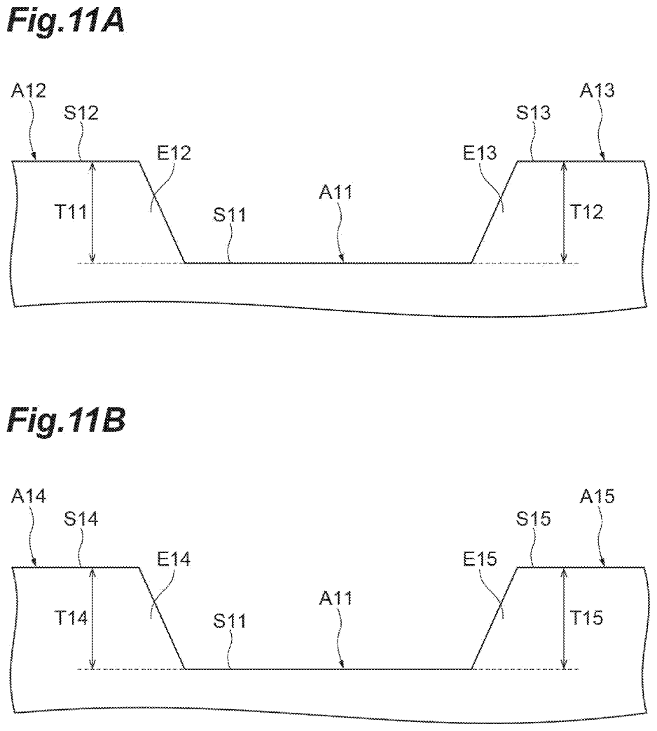

FIG. 11A is a view schematically showing the first region A11, the second region A12, and the third region A13 of the second main surface 3b, and FIG. 11B is a view schematically showing the first region A11, the fourth region A14, and the fifth region A15 of the second main surface 3b. As shown in FIG. 11A, protrusion amounts of the second region A12 and the third region A13 relative to the first region A11 are equivalent. That is, a height position of a surface S12 of the second region A12 and a height position of a surface S13 of the third region A13 are equivalent. The protrusion amount of the second region A12 relative to the first region A11, that is, a distance T11 between the surface S12 of the second region A12 and a surface S11 of the first region A11 is 10 μm to 200 μm. Similarly, the protrusion amount of the third region A13 relative to the first region A11, that is, a distance T12 between the surface S13 of the third region A13 and the surface S11 of the first region A11 is 10 μm to 200 μm.

As shown in FIG. 11B, protrusion amounts of the fourth region A14 and the fifth region A15 relative to the first region A11 are equivalent. That is, a height position of a surface S14 of the fourth region A14 and a height position of a surface S15 of the fifth region A15 are equivalent. The protrusion amount of the fourth region A14 relative to the first region A11, that is, a distance T14 between the surface S14 of the fourth region A14 and the surface S11 of the first region A11 is 10 μm to 200 μm. Similarly, the protrusion amount of the fifth region A15 relative to the first region A11, that is, a distance T15 between the surface S15 of the fifth region A15 and the surface S11 of the first region A11 is 10 μm to 200 μm.

The distance T11, the distance T12, the distance T14, and the distance T15 are equal to or less than a maximum thickness (dimension in the first direction D1) of each of the first terminal 11, the second terminal 13, the third terminal 15, and the fourth terminal 17. The distance T11, the distance T12, the distance T14, and the distance T15 are equal to or greater than a difference between a maximum and a minimum of a dimension protruding from the first region A11 of the second main surface 3b of the element body 3 for each of the first terminal 11, the second terminal 13, the third terminal 15, and the fourth terminal 17.

As shown in FIG. 11A, each of an edge portion E12 of the second region A12 adjacent to the first region A11 and an edge portion E13 of the third region A13 adjacent to the first region A11 has a protrusion amount that becomes smaller toward the first region A11. Each of the edge portion E12 of the second region A12 and the edge portion E13 of the third region A13 has a tapered shape that tapers toward the first region A11.

As shown in FIG. 11B, each of an edge portion E14 of the fourth region A14 adjacent to the first region A11 and an edge portion E15 of the fifth region A15 adjacent to the first region A11 has a protrusion amount that becomes smaller toward the first region A11. Each of the edge portion E14 of the fourth region A14 and the edge portion E15 of the fifth region A15 has a tapered shape that tapers toward the first region A11.

An area of the first region A11 is smaller than an area obtained by summing respective areas of the second region A12, the third region A13, the fourth region A14, and the fifth region A15. That is, a ratio occupied by the first region A11 in the second main surface 3b is smaller than a ratio occupied by the second region A12, the third region A13, the fourth region A14, and the fifth region A15.

Subsequently, arrangement of the first terminal 11, the second terminal 13, the third terminal 15, and the fourth terminal 17 will be described in detail.

The first terminal 11 is disposed in the second region A12 on the second main surface 3b. In the present embodiment, the surface of the first terminal 11 is substantially flush with the surface S12 of the second region A12. The second terminal 13 is disposed in the fourth region A14 on the second main surface 3b. In the present embodiment, the surface of the second terminal 13 is substantially flush with the surface S14 of the fourth region A14.

The third terminal 15 is disposed in the third region A13 on the second main surface 3b. In the present embodiment, the surface of the third terminal 15 is substantially flush with the surface S13 of the third region A13. The fourth terminal 17 is disposed in the fifth region A15 on the second main surface 3b. In the present embodiment, the surface of the fourth terminal 17 is substantially flush with the surface S15 of the fifth region A15.

The first terminal 11 and the second terminal 13 are disposed with the first region A11 interposed therebetween. The first terminal 11 and the third terminal 15 are disposed with the first region A11 interposed therebetween. The third terminal 15 and the fourth terminal 17 are disposed with the first region A11 interposed therebetween. The second terminal 13 and the fourth terminal 17 are disposed with the first region A11 interposed therebetween.

As shown in FIG. 10, a distance L1 between the first terminal 11 and an edge of the second region A12 in the third direction D3 is longer than distances L2, L3 between the first terminal 11 and edges of the second region A12 in the second direction D2 (L1>L2, L3). The same applies to the second terminal 13 and the fourth region A14, the third terminal 15 and the third region A13, and the fourth terminal 17 and the fifth region A15.

As described above, in the inductor 1A according to the present embodiment, the second main surface 3b of the element body 3 has the first region A11, the second region A12, the third region A13, the fourth region A14, and the fifth region A15. The second region A12, the third region A13, the fourth region A14, and the fifth region A15 protrude to the outside of the element body 3 relative to the first region A11. That is, the first region A11 is recessed (depressed) relative to the second region A12, the third region A13, the fourth region A14, and the fifth region A15. In this configuration, the first terminal 11 is disposed in the second region A12, the second terminal 13 is disposed in the fourth region A14, the third terminal 15 is disposed in the third region A13, and the fourth terminal 17 is disposed in the fifth region A15. Accordingly, when mounting the inductor 1A (the first terminal 11, the second terminal 13, the third terminal 15, the fourth terminal 17) to a circuit board or the like with solder, a space is formed between the first region A11 of the element body 3A and the circuit board. Therefore, since solder can flow between the element body 3A and the circuit board, it is possible to suppress solder from remaining between the element body 3A and the circuit board. Therefore, in the inductor 1A, it is possible to suppress occurrences of short circuits with solder between the first and second terminals 11, 13 and the third and fourth terminals 15, 17. As a result, in the inductor 1A, occurrence of a short circuit defect during mounting can be suppressed.

In the inductor 1A according to the present embodiment, the distance L1 between the first terminal 11 and the edge of the second region A12 in the third direction D3 is longer than the distances L2, L3 between the first terminal 11 and the edges of the second region A12 in the second direction D2 (L1>L2, L3). This configuration makes it possible to suppress occurrence of a short circuit defect between the first coil conductor 7 and the second coil conductor 9.

Although the embodiments of the present disclosure have been described above, the present disclosure is not necessarily limited to the above-described embodiments, and various modifications can be made without departing from the gist thereof.

In the above embodiment, a form in which the first terminal 11 and the second terminal 13 protrude to the outside relative to the third side surface 3e of the element body 3, and the third terminal 15 and the fourth terminal 17 protrude to the outside relative to the fourth side surface 3f of the element body 3 has been described as an example. However, end surfaces (tips) of the first terminal 11 and the second terminal 13 may be flush with the third side surface 3e, and end surfaces (tips) of the third terminal 15 and the fourth terminal 17 may be flush with the fourth side surface 3f.

In the above embodiment, structures of the first magnetic block 5A, the second magnetic block 5B, and the third magnetic block 5C, and the first coil conductor 7 and the second coil conductor 9 are not limited. Also, in the above embodiment, a form in which the inductors 1, 1A include the first magnetic block 5A, the second magnetic block 5B, and the third magnetic block 5C has been described as an example. However, the inductor may not include a magnetic block.

In the above embodiment, a form in which the first terminal 11, the second terminal 13, the third terminal 15, and the fourth terminal 17 are partially located inside the element body 3 and partially exposed from the second main surface 3b of the element body 3 has been described as an example. However, the first terminal 11, the second terminal 13, the third terminal 15, and the fourth terminal 17 may be disposed on the second main surface 3b of the element body 3.

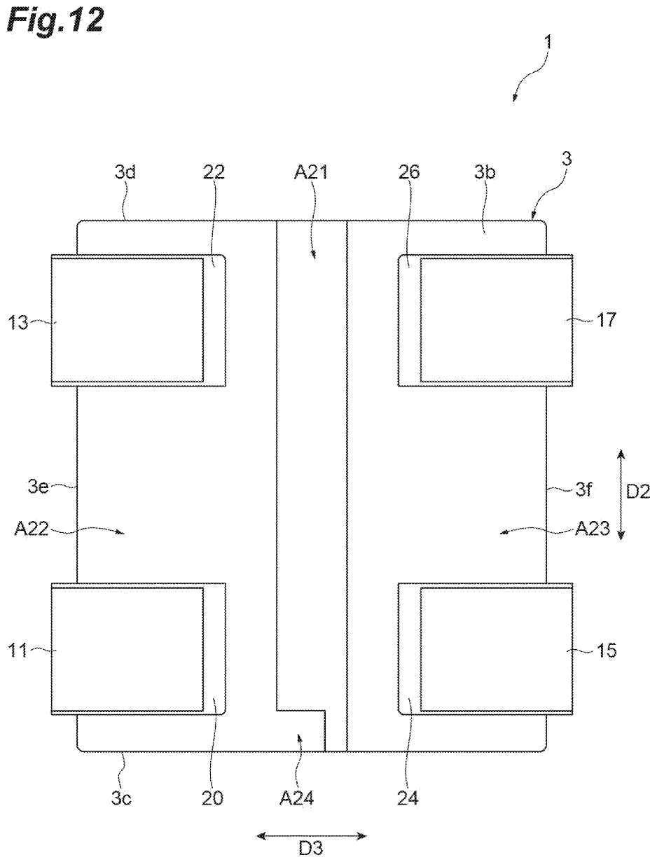

In the above first embodiment, a form in which the first region A1 has a predetermined width (constant width) between the first side surface 3c and the second side surface 3d of the element body 3 and extends in the second direction D2 has been described as an example. However, as shown in FIG. 12, a width of a part of a first region A21 may be narrowed. In an example shown in FIG. 12, a second region A22 has a protruding region A24 protruding toward a third region A23 on the first side surface 3c side of the element body 3. That is, the width of the first region A21 is narrowed on the first side surface 3c side of the element body 3. This configuration makes it possible to increase a volume of the element body 3 by the protruding region A24 in a portion located at an end portion on the first side surface 3c side of the element body 3. This makes it possible to increase rigidity of the element body 3.

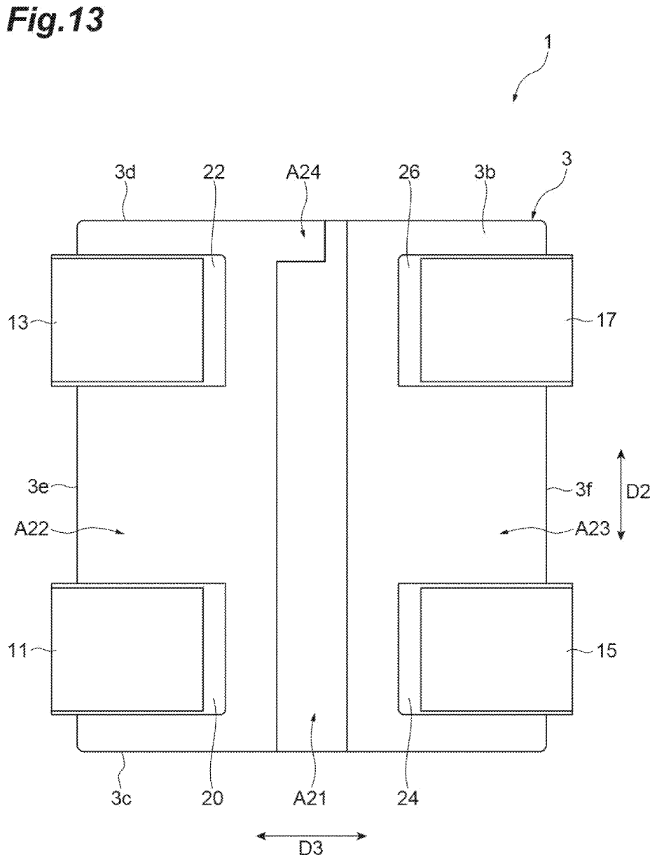

Also, as shown in FIG. 13, the second region A22 may have a protruding region A24 protruding toward the third region A23 on the second side surface 3d side of the element body 3. This configuration also makes it possible to increase the volume of the element body 3 in a portion located at an end portion on the second side surface 3d side of the element body 3. This makes it possible to increase rigidity of the element body 3.

Also, the second region A22 may have two protruding regions A24 protruding toward the third region A23 on each of the first side surface 3c side and the second side surface 3d side of the element body 3. Also, the third region may have a protruding region protruding toward the second region on the first side surface 3c side of the element body 3, may have a protruding region protruding toward the second region on the second side surface 3d side of the element body 3, or may have a protruding region protruding toward the second region on each of the first side surface 3c side and the second side surface 3d side of the element body 3. Alternatively, one of the second region and the third region may have a protruding region protruding toward the other of the second region and the third region on the first side surface 3c side of the element body 3, and the other of the second region and the third region may have a protruding region protruding toward the one of the second region and the third region on the second side surface 3d side of the element body 3.

As understood from the above description, the present specification discloses the following.

### Supplementary Note 1:

An inductor comprising:
an element body formed by including a resin;
a first coil conductor disposed in the element body;
a second coil conductor disposed in the element body;
a first terminal connected to the first coil conductor and exposed from a surface on one side in a first direction of the element body;
a second terminal connected to the first coil conductor and exposed from the surface on the one side;
a third terminal connected to the second coil conductor and exposed from the surface on the one side; and
a fourth terminal connected to the second coil conductor and exposed from the surface on the one side,
wherein the first terminal and the second terminal are disposed apart from each other in a second direction orthogonal to the first direction,
the third terminal and the fourth terminal are disposed apart from each other in the second direction,
the surface on the one side has a first region, a second region and a third region, the second region and the third region protruding further out from the element body in the first direction than the first region,
the first region is provided between the second region and the third region in a third direction orthogonal to the first direction and the second direction,
the first terminal is disposed in the second region, and
the third terminal is disposed in the third region.

### Supplementary Note 2:

The inductor according to Supplementary Note 1,
wherein the first coil conductor has a first conductor extending in the first direction, a second conductor extending in the first direction and disposed facing the first conductor in the second direction, and a third conductor connecting the first conductor and the second conductor,
the second coil conductor has a fourth conductor extending in the first direction, a fifth conductor extending in the first direction and disposed facing the fourth conductor in the second direction, and a sixth conductor connecting the fourth conductor and the fifth conductor,
the first conductor is connected to the first terminal,
the second conductor is connected to the second terminal,
the fourth conductor is connected to the third terminal, and
the fifth conductor is connected to the fourth terminal.

### Supplementary Note 3:

The inductor according to Supplementary Note 1 or Supplementary Note 2,
wherein the second terminal is disposed in the second region, and
the fourth terminal is disposed in the third region.

### Supplementary Note 4:

The inductor according to any one of Supplementary Note 1 to Supplementary Note 2, wherein an area of the first region is smaller than an area obtained by summing respective areas of the second region and the third region.

### Supplementary Note 5:

The inductor according to Supplementary Note 1 or Supplementary Note 2,
wherein the surface on the one side of the element body has a fourth region and a fifth region protruding further out from the element body in the first direction than the first region,
the first region is provided between the second region and the fourth region and between the third region and the fifth region in the second direction, and is provided between the fourth region and the fifth region in the third direction,
an area of the first region is smaller than an area obtained by summing respective areas of the second region and the third region,
the second terminal is disposed in the fourth region, and
the third terminal is disposed in the fifth region.

### Supplementary Note 6:

The inductor according to Supplementary Note 5, wherein a distance between the first terminal and an edge of the second region in the third direction is longer than a distance between the first terminal and an edge of the second region in the second direction.

### Supplementary Note 7:

The inductor according to any one of Supplementary Note 1 to Supplementary Note 6, wherein a protrusion amount of an edge portion of each of the second region and the third region becomes smaller toward the first region.

### Supplementary Note 8:

The inductor according to any one of Supplementary Note 1 to Supplementary Note 7, wherein a distance in the first direction between a surface of each of the second region and the third region and a surface of the first region is equal to or greater than a difference between a maximum value and a minimum value of a distance between a surface of each of the first terminal, the second terminal, the third terminal, and the fourth terminal and the surface of the first region.

### Supplementary Note 9:

The inductor according to any one of Supplementary Note 1 to Supplementary Note 8, wherein a distance in the first direction between a surface of each of the second region and the third region and a surface of the first region is equal to or less than a maximum thickness of each of the first terminal, the second terminal, the third terminal, and the fourth terminal.

### Supplementary Note 10:

The inductor according to any one of Supplementary Note 1 to Supplementary Note 9, wherein a tip of each of the first terminal, the second terminal, the third terminal, and the fourth terminal is flush with the element body or protrudes from the element body when viewed from the first direction.

### Supplementary Note 11:

The inductor according to any one of Supplementary Note 1 to Supplementary Note 10, wherein the element body is formed by including a magnetic resin.

### Supplementary Note 12:

The inductor according to any one of Supplementary Note 1 to Supplementary Note 11, further comprising a first magnetic block, a second magnetic block, and a third magnetic block disposed in the element body,
wherein the first magnetic block, the second magnetic block, and the third magnetic block are disposed apart from each other in the third direction,
the first coil conductor is disposed between the first magnetic block and the second magnetic block, and
the second coil conductor is disposed between the second magnetic block and the third magnetic block.

### Supplementary Note 13:

The inductor according to Supplementary Note 12, wherein a magnetic permeability of each of the first magnetic block, the second magnetic block, and the third magnetic block is higher than a magnetic permeability of the element body.

### Supplementary Note 14:

The inductor according to any one of Supplementary Note 1 to Supplementary Note 13, further comprising:
a first insulating member provided between the first terminal and the element body;
a second insulating member provided between the second terminal and the element body;
a third insulating member provided between the third terminal and the element body; and
a fourth insulating member provided between the fourth terminal and the element body.

### Supplementary Note 15:

The inductor according to any one of Supplementary Note 1 to Supplementary Note 14, wherein each of the first terminal, the second terminal, the third terminal, and the fourth terminal protrudes from the element body in a direction orthogonal to the first direction.

### Supplementary Note 16:

The inductor according to any one of Supplementary Note 1 to Supplementary Note 15, wherein protrusion amounts of the second region and the third region relative to the first region are equivalent to each other.

### Supplementary Note 17:

The inductor according to any one of Supplementary Note 1 to Supplementary Note 16, wherein protrusion amounts of the second region and the third region relative to the first region are 10 μm or more and 200 μm or less.

Supplementary Note 18:

The inductor according to any one of Supplementary Note 1 to Supplementary Note 17,
wherein a surface of the first terminal and a surface of the second terminal are substantially flush with a surface of the second region, and
a surface of the third terminal and a surface of the fourth terminal are substantially flush with a surface of the third region.

### Supplementary Note 19:

The inductor according to any one of Supplementary Note 1 to Supplementary Note 18,
wherein the second region extends from one side surface side to another side surface side of the element body in the second direction, and
the third region extends from the one side surface side to the other side surface side of the element body in the second direction.

### Supplementary Note 20:

A DC-DC converter comprising the inductor according to any one of Supplementary Note 1 to Supplementary Note 19.

What is claimed is:

1. An inductor comprising:
an element body formed by including a resin;
a first coil conductor disposed in the element body;
a second coil conductor disposed in the element body;
a first terminal connected to the first coil conductor and exposed from a surface on one side in a first direction of the element body;
a second terminal connected to the first coil conductor and exposed from the surface on the one side;
a third terminal connected to the second coil conductor and exposed from the surface on the one side; and
a fourth terminal connected to the second coil conductor and exposed from the surface on the one side,
wherein the first terminal and the second terminal are disposed apart from each other in a second direction orthogonal to the first direction,
the third terminal and the fourth terminal are disposed apart from each other in the second direction,
the surface on the one side has a first region, a second region and a third region, the second region and the third region protruding further out from the element body in the first direction than the first region,
the first region is provided between the second region and the third region in a third direction orthogonal to the first direction and the second direction,
the first terminal is disposed in the second region, and
the third terminal is disposed in the third region.

2. The inductor according to claim 1,
wherein the first coil conductor has a first conductor extending in the first direction, a second conductor extending in the first direction and disposed facing the first conductor in the second direction, and a third conductor connecting the first conductor and the second conductor,
the second coil conductor has a fourth conductor extending in the first direction, a fifth conductor extending in the first direction and disposed facing the fourth conductor in the second direction, and a sixth conductor connecting the fourth conductor and the fifth conductor,
the first conductor is connected to the first terminal,
the second conductor is connected to the second terminal,
the fourth conductor is connected to the third terminal, and
the fifth conductor is connected to the fourth terminal.

3. The inductor according to claim 1,
wherein the second terminal is disposed in the second region, and
the fourth terminal is disposed in the third region.

4. The inductor according to claim 1, wherein an area of the first region is smaller than an area obtained by summing respective areas of the second region and the third region.

5. The inductor according to claim 1,
wherein the surface on the one side of the element body has a fourth region and a fifth region protruding further out from the element body in the first direction than the first region,
the first region is provided between the second region and the fourth region and between the third region and the fifth region in the second direction, and is provided between the fourth region and the fifth region in the third direction,
an area of the first region is smaller than an area obtained by summing respective areas of the second region and the third region,
the second terminal is disposed in the fourth region, and
the third terminal is disposed in the fifth region.

6. The inductor according to claim 5, wherein a distance between the first terminal and an edge of the second region in the third direction is longer than a distance between the first terminal and an edge of the second region in the second direction.

7. The inductor according to claim 1, wherein a protrusion amount of an edge portion of each of the second region and the third region becomes smaller toward the first region.

8. The inductor according to claim 1, wherein a distance in the first direction between a surface of each of the second region and the third region and a surface of the first region is equal to or greater than a difference between a maximum value and a minimum value of a distance between a surface of each of the first terminal, the second terminal, the third terminal, and the fourth terminal and the surface of the first region.

9. The inductor according to claim 1, wherein a distance in the first direction between a surface of each of the second region and the third region and a surface of the first region is equal to or less than a maximum thickness of each of the first terminal, the second terminal, the third terminal, and the fourth terminal.

10. The inductor according to claim 1, wherein a tip of each of the first terminal, the second terminal, the third terminal, and the fourth terminal is flush with the element body or protrudes from the element body when viewed from the first direction.

11. The inductor according to claim 1, wherein the element body is formed by including a magnetic resin.

12. The inductor according to claim 1, further comprising a first magnetic block, a second magnetic block, and a third magnetic block disposed in the element body,
wherein the first magnetic block, the second magnetic block, and the third magnetic block are disposed apart from each other in the third direction,
the first coil conductor is disposed between the first magnetic block and the second magnetic block, and
the second coil conductor is disposed between the second magnetic block and the third magnetic block.

13. The inductor according to claim 12, wherein a magnetic permeability of each of the first magnetic block, the second magnetic block, and the third magnetic block is higher than a magnetic permeability of the element body.

14. The inductor according to claim 1, further comprising:
a first insulating member provided between the first terminal and the element body;
a second insulating member provided between the second terminal and the element body;
a third insulating member provided between the third terminal and the element body; and
a fourth insulating member provided between the fourth terminal and the element body.

15. The inductor according to claim 1, wherein each of the first terminal, the second terminal, the third terminal, and the fourth terminal protrudes from the element body in a direction orthogonal to the first direction.

16. The inductor according to claim 1, wherein protrusion amounts of the second region and the third region relative to the first region are equivalent to each other.

17. The inductor according to claim 1, wherein protrusion amounts of the second region and the third region relative to the first region are 10 μm or more and 200 μm or less.

18. The inductor according to claim 1,
wherein a surface of the first terminal and a surface of the second terminal are substantially flush with a surface of the second region, and
a surface of the third terminal and a surface of the fourth terminal are substantially flush with a surface of the third region.

19. The inductor according to claim 1,
wherein the second region extends from one side surface to another side surface of the element body in the second direction, and
the third region extends from the one side surface to the other side surface of the element body in the second direction.

20. A DC-DC converter comprising the inductor according to claim 1.
